(19) United States
(12) Patent Application Publication
(10) Pub. No.: US 2006/0036450 A1
(43) Pub. Date: Feb. 16, 2006

(54) Method and apparatus for air and bus charter management via wide area network in the gaming industry

(75) Inventors: George Joseph Nassef JR., Las Vegas, NV (US); Jeffrey S. Yang, Las Vegas, NV (US); Kelly A Michaelian, Las Vegas, NV (US)

Correspondence Address: VALETNOIR INC - A NEW YORK CORPORATION, 1140 BROADWAY, SUITE 903, NEW YORK, NY, 10001, US

(73) Assignee: VALETNOIR INC., Las Vegas, NV (US)

(21) Appl. No.: 10/710,960

(22) Filed: Aug. 14, 2004

(51) Int. Cl. G06Q 99/00

(52) U.S. Cl. 705/1; 705/80

(57) ABSTRACT

This invention relates to the art of reservations management, and, more specifically, to a distributed system for a casino establishment to plan and arrange for passengers on air and coach charters traveling to and from a casino establishment via a wide area network. This invention allows for the remote management of names and personal information in a distributed environment and/or player self-service wherein a player may introduce their own name and credentials to the system, have the system apply rules to the approval of the trip, and ultimately track all seat and manifest information.

### BACKGROUND OF INVENTION

1. Field of the Invention

This invention relates to the art of reservations management, and, more specifically, to a distributed system for a casino establishment to plan and arrange for passengers on air and coach charters traveling to and from a casino establishment via a wide area network. This invention allows for the remote management of names and personal information in a distributed environment and/or player self-service wherein a player may introduce their own name and credentials to the system, have the system apply rules to the approval of the trip, and ultimately track all seat and manifest information.

2. Description of Prior Art

The current means of maintaining records of charter passengers include, but are not limited to manual records, Computer Reservations Systems (CRS Systems) like SABRE, WorldSpan, Amadeus, General Distribution Systems (GDS), desktop systems in use by Travel Agencies and Tour Operators, faxes, telephones, and electronic mail. Others, casinos specifically rely on hotel management systems and often manual record keeping to record various aspects of the personal information of a traveler booked on a bus or airplane charter, or code-share flight.

Players, tour managers and casino personnel likewise must in turn devote a great amount of resource to finding a list of seat numbers, passengers who have boarded, and other flight and travel information through printed material or the interaction of many records of detail within the hotel management system itself. In addition, these system fail to maintain or enforce specific trip or destination rules for the trip qualification (free for certain levels of players), which are usually tracked manually by a staff of people within the casino or tour operator. In some cases, a casino employee designated as the coordinator for all flights and charter trips records specifics to each trip and each player expected to be on a particular trip in a paper notebook, which if lost, would cause great economic impact to properties.

Many disadvantages are inherent in this conventional manual method. For instance, a casino has a limited amount of time to handle players. Further, a casino representative traveling along on the trip might want to offer improved customer service to passengers on a weighted basis based upon their potential value to the casino in future and past play. Often, traditional methods of recording boarded passengers lacks this level of value information presented in a useful form to someone providing point of departure or arrival service.

While a desktop, office or GDS system is a useful tool for handling the economics of the trip to bring individuals or family members traveling together to a property, it lacks casino-specific rules which can be displayed, updated or altered from a central location.

Therefore, a continuing need exists for a system which will record all pertinent information surrounding the boarding passengers of a air, bus or other charter flight or trip to a single or multiple casino destination while while enforcing a set of complex business rules, gaming desires, property-specific criteria, and other phase and state information required for a successful transaction and which can be operated by a lay person not mentally controlling the process or by the player in a self-service mode themselves via the World Wide Web or other such wide area network.

The need for a better method for providing a passenger manifest system for players services within the gaming industry operating air, bus and other transportation charters in a manner that does not require the devotion of great resources shows that there is still room for improvement within the art.

### SUMMARY OF INVENTION

An object of the present invention comprises a method and apparatus for providing a game of chance player (casino player) with the ability to remotely subscribe to an air or bus charter, become listed as a passenger on that transportation to a gaming facility, and be remotely listed and managed by one or more service personnel from the casino property via a computer network, such as the Internet, and to directly control the process and all related facts surrounding the complete interaction of the process between the player, the casino and the transportation company.

A further object of the present invention is to provide a method and apparatus which monitors the transactions and automatically notifies the transportation manager and casino when a rule is violated during the process, lists passenger's seats, current passenger value or status in the casino promotion system and any off-schedule operations of the transportation which might impact the service level of the transportation provider.

A further object of the present invention is to provide a method and apparatus which enables a plurality of passengers, transportation providers, or gaming service providers to manage a plurality of players via a global computer information network, such as the Internet.

A further object of the present invention is to provide a method and apparatus which enables both new and pre-qualified players to access the transportation or historical status of the interactions via a global computer information network.

The above objects are substantially achieved by providing a computer and software program, recorded on a computer-readable medium, for controlling the computer of a potential casino player to maintain and generate a listing of players, maintain important rules of the trade, rules specific to the destinations and business logic of the expected transaction. The software program interacts with the database of information and applies the business rules to create lists of players, alerts, emails, and other data that can be accessed via the Internet. Specifically, the software program is adapted to be run by a transportation provider's computer to control the computer to generate a computer readable file (charter file) that includes information pertaining to travelers, trips, contacts, companies, and transactions that can be accessed from a remote site via the Internet. For example, these files can be posted as a Web site on the World Wide Web.

The current invention can utilize the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a Hypertext Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The system is more efficient, effective, accurate and functional than the current art.

Without restricting the full scope of this invention, the preferred form of this invention is illustrated in the following drawings: FIG. 1 shows an overview of how a User accesses the system through the Internet; FIG. 2 shows a sample of users computer connecting to the system; and FIG. 3 shows the system sending a message to a transportation service provider.

The system is more efficient, effective, accurate and functional than the current art.

Glossary of Terms

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (Hypertext Transfer Protocol): protocol used between a browser and a Web server to exchange Web pages and other data over the Internet.

Hypertext: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2 shows a sample of users computer connecting to the system; and

FIG. 3 shows the system sending a message to a transportation service provider.

### DETAILED DESCRIPTION

The following description is demonstrative in nature and is not intended to limit the scope of the invention or its application of uses.

There are a number of significant design features and improvements incorporated within the invention.

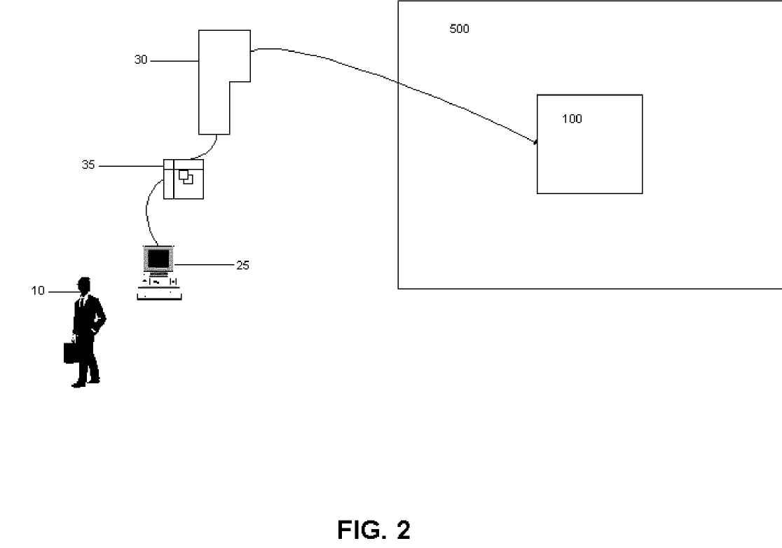

As shown in FIG. 2, the present invention comprises a computer 25 with the software 35 program recorded on a computer-readable medium 30, for controlling the computer of a potential transportation service provider to maintain and generate a listing of travelers, maintain important rules of the trade, rules specific to the destinations and business logic of the expected transaction. The software program interacts with the database of information and applies the business rules to create lists of travelers, alerts, emails, and other data that can be accessed via the Internet. Specifically, the software program is adapted to be run by a transportation service provider's computer to control the computer to generate a computer readable file (charter file) that includes information pertaining to travelers, trips, contacts, companies, and transactions that can be accessed from a remote site via the Internet 500. For example, these files can be posted as a Web site 100 on the World Wide Web 500.

The present invention comprises a method and apparatus for providing a game of chance player 120, such as a casino player, air and bus charter management system for players 120 serviced within a business that are being transported to and from a casino establishment by an transportation service provider (called a charter) service. More specifically, the present invention relates to a method and apparatus which enables charter providers to record all aspects of the relationship of a player 120 during the enlisting, transporting, displaying, servicing, and returning and post-trip service process by maintaining a database 310 of phase and state information pertaining to the transaction used in the business to transport players 120 to their destination. The current invention accomplishes this via a global computer information network, such as the Internet 500, to record data relevant to the transaction while enforcing a series of business rules which must be followed during the transaction as defined by the charters business operation. These rules must be followed to satisfy certain legal, regulatory or common-sense guidelines during the booking process and are inherent in the system.

The present invention further enables charter or casino personnel to use the Internet 500 to manage the transaction, perform reporting, create graphical representations of the transportation vehicle, the value of the transactions, the destinations and relative business being formed at each of the charter's business destinations or offices, verify staff and internal personnel performance, create graphs and other reports both online and offline on the relative performance of customer service personnel performing the functions on the part of the charter.

The computer application that includes the user interface for this invention will henceforth be referred to as the “System 1.” The system is network-based and works on an Internet, Intranet and/or Wireless network basis as well as a stand-alone and fax-based system.

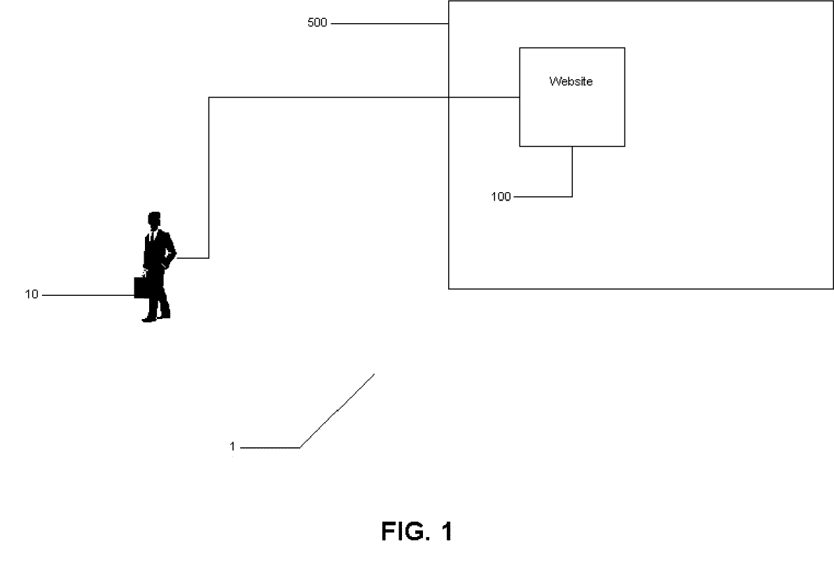

FIG. 1 illustrates a functional diagram of a computer network for World Wide Web 500 access to the System 1 from a plurality of Users 10 who access the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, or American Online, etc. or Wireless devices using services like AT&T or Verizon.

The Users 10 contact the System Web Site 100 using an informational processing system (Client) capable of running an HTML compliant Web browser such as Microsoft's Internet Explorer, Netscape Navigator, Lynx or Mosaic. A typical system that is used is a personal computer with an operating system such as Windows 95, 98 or ME, NT, 2000 or Linux running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 and/or Service Providers 20 connect to the System Web Site 100. In the preferred embodiment the system has numerous web pages. The information in the web pages are in HTML format via the HyperText Transport Protocol (http) and on Server System database 310. The User System 110 includes software to allow viewing of web pages, commonly referred to as a Web Browser, such as Communicator available from Netscape Communications Corp. or Internet Explorer available from Microsoft Corp. The user system is capable of accessing web pages located on Server System database 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The system 1 is set to run on a computing device. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The computing device can serve as a server.

The invention comprises a method and apparatus for providing a game of chance player customer relationship management system for players 120 serviced within a business that are being provided to a casino establishment by an independent broker service.

The system 1 enables transportation service providers (charters) to record data relevant to the transaction of delivery of players 120 to casinos including, but not limited to: the methods of transportation, departure date and time, arrival date and time, seat number, fellow passengers, qualifying information, personal data, pictures, personnel greeting and meeting information, alerts, probability of travel coming to fruition, charges related to the trip, group leaders and other attributes associated with the other individuals joining the charter trip, percentages of commissions to be payable to the charter or transportation company upon completion of the trip, actual payments received by the charter manager for past trips by the same player 120, confirmation of itinerary, itinerary generation, automatic generation of specific reservations information required by the target property or casino destination, electronic verification and self-service features for players to self-confirm travel booking completion, wholesale costs of services provided along the trip, and feedback from customers collected during the course of interaction between the system and the player 120 during the booking process or following the trip. These items are stored on the system's database 310. The system 1 enforces business rules and logic required by the charters' business against these data to ensure that a business process is followed that maximizes casino play and travel.

Charter or casino staff members as Users 10 can search this collection of data from the database using a series of qualifying criteria or context criteria, including seat map, GPS data projected by the transportation vehicle itself, mapping data to locate individual players or groups of players en-route, booking phase, demographics, destintion, profit and loss, play history, and other personal information that may be of interest to a junket organization.

The system 1 further enables a player 120 to be searched from a multiplicity of such players, based upon their play or travel history. The method and apparatus further enables a player 120 to be searched based upon their desired destination. The method and apparatus further enables a player 120 to be searched based on their preferred games or style of playing games of chance. Standard search methodology that is commonly known in the art is used.

The system 1 enables the charter manager, player 120 or casino service personnel, as a User 10, to verify the traveler's profile information in real-time, batch or via the Internet with remote computer systems operated by the casino service provider for the purposes of scoring the traveler's profile against actual data collected during a previous visit of the player 120 to the casino service provider. The system 1 as a web-based system permits any licensed user 10 to book players 120 via the web directly into a casino's or hotel systems.

The system 1 will enable the representative, player or casino service personnel, as a User 10, to use this score against a series of criteria (rules) that match the casino service providers desired customers for a specific future travel data specified by the representative, player or casino service personnel. This allows the representative, player or casino service personnel to concentrate on those players 120 that match specific criteria.

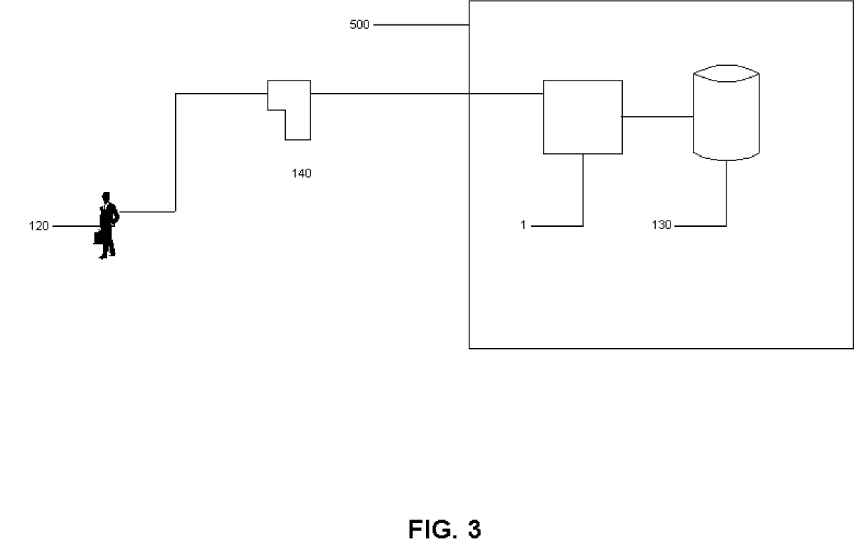

The system 1 is connected to other databases and computer systems, such as a GDS or CRS operated by the airlines, train companies, bus companies 130, allowing it the capable of monitoring gaming service provider seat inventories, gaming space, and desired travelers and notifying the player 120 when a charter service provider has openings for which the player is qualified and/or interested in is made available by the gaming service provider. The system 1 can notify the player 120 and/or the charter service provider 20 through E-mail, mail, phone, fax or any other means of communications 140 as shown in FIG. 3.

The system 1 allows a plurality of charter service providers, casino staff members, and players 120 as users 10 to interact at a single location accessible via a global computer information network. The system 1 has a communications function that further enables a player and the charter representative to communicate directly with a gaming service provider facility, such as a casino, via the Internet if the traveler is interested in completing the plans for the player's next experience at the gaming service provider's facility via a charter (booking).

The system 1 provides a method and apparatus which enables both new and pre-qualified players to access the current or historical status of the interactions via a global computer information network. The system 1 can be used by charter managers and casino marketing who deal solely with charters.

The system 1 allows a plurality of casino service providers to monitor the transactions and automatically notifies the charter staff when a rule is violated during the booking or interaction process.

Advantages

The previously described version of the present invention has many advantages. It provides a system for providing a game of chance player (casino player) air and bus charter management system, it provides a method and apparatus to monitor the transactions and automatically notifies the charter manager and casino when a rule is violated during the travel process, or during off-schedule operations, it provides a method and apparatus which enables a plurality of charter providers or casinos manage a plurality of players via a global computer information network, and it provides a method and apparatus which enables both new and pre-qualified travelers to access the current or historical status of the interactions via a global computer information network. Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. air and bus charter management system comprising:
having a database;
having said database contain data about a traveler to and from a casino; and
allowing said data to be accessed by users of the system.

2. A charter management system of claim 1 further comprising having said system being accessible by a user through the Internet.

3. A charter management system of claim 1 further comprising having said data being historic data of said traveler.

4. A charter management system of claim 3 further comprising having said historic data being the travel history, seat assignments, companions of said traveler.

5. A charter management system of claim 6 further comprising having said other database systems being used to form a charter.

6. A charter management system of claim 1 further comprising having said system contacting said gaming player.

7. A charter management system of claim 8 further comprising where said traveler is contacted based on a selection criteria.

8. A customer relationship management system of claim 9 further comprising where said selection criteria is based on the information contained in said database.

9. A charter management system of claim 1 further comprising where said system compares said data against a rule set.

10. A charter management system of claim 11 further comprising where said system will notify if a rule set is broken.

11. A charter management system of claim 1 further comprising where said system has a communication means for players and users to contact each other.

12. A charter management system of claim 8 further comprising where said notification is an E-mail.

13. A charter management system of claim 8 further comprising where said notification is mailing.

14. A charter management system of claim 8 further comprising where said notification is telephonic.

15. A charter management system of claim 6 further comprising where said other databases are reservations systems databases.

16. A charter management system of claim 1 further comprising having said users searching bases on qualifying criteria.

17. A charter management system of claim 8 further comprising having said users searching for a plurality of travelers based on their travel information.

18. A charter management system of claim 8 further comprising having said users searching for a plurality of travelers based on their travel history.
